(19) United States
(12) Patent Application Publication
(10) Pub. No.: US 2008/0293604 A1
(43) Pub. Date: Nov. 27, 2008

(54) Dosage Element

(75) Inventors: Karl Ludwig Gibis, Limburgerhof (DE); Chris Efstathios Housmekerides, Ludwigshafen (DE)

Correspondence Address: NORRIS, MCLAUGHLIN & MARCUS, 875 THIRD AVE, 18TH FLOOR, NEW YORK, NY, 10022, US

(73) Assignee: RECKITT BENCKISER N.V., Hoofddorp (NL)

(21) Appl. No.: 12/092,634

(22) PCT Filed: Oct. 30, 2006
(86) PCT No.: PCT/GB06/04021

§ 371 Date: Jun. 23, 2008

(30) Foreign Application Priority Data
Nov. 7, 2005 (GB) 0522660.0
Jan. 21, 2006 (GB) 0601247.0

(51) Int. Cl. C11D 17/00

(52) U.S. Cl. 510/220

(57) ABSTRACT

Laundry or dishwasher detergent elements (5) are of elongate shape. They may be set into an array which is which is the refill of a multi-wash dispensing device for use in a cleaning machine.

This invention relates to a dosage element of a cleaning composition.

A “dosage element” as used herein is a body which dissolves in use in a ware washing machine, for example a dishwashing machine or a laundry washing machine.

Cleaning composition can be supplied to ware washing machines as powders, liquids, gels or as solid bodies (by which we include, for example, blocks which have been compressed, or extruded).

Such dosage elements in the form of solid bodies are conventionally generally cuboid, of size approximately 38 mm by 27 mm by 15 mm, and of weight approximately 20 g. They are typically loaded into the machine's dispensing compartment or drawer, in which they are dissolved by a flow of water, or from which they fall or are conveyed into the washing chamber of the machine, where they are dissolved by the water present.

We have undertaken work on new ways of dispensing cleaning composition into a ware washing machine and have come to appreciate that a cuboid solid body dosage element is a good form for handling by the consumer and conveying into the machine, one per wash, but is by no means optimal for potential new ways of dispensing cleaning composition.

In accordance with a first aspect of the present invention there is provided a dosage element of a cleaning composition, having an elongate shape.

Preferably the dosage element of the invention is in the form of a solid block. Preferably it is an extruded or compacted or injection moulded body.

Suitably a dosage element of the invention is in the form of a rod or stick. A dosage element of the invention is preferably monolithic but in some embodiments the dosage element is constituted by two or more pieces set end-to-end, able to serve as a single charge of cleaning composition during a washing operation; for example such pieces may be held together end-to-end in a holder, which may be in the form of a pocket, pouch or sleeve.

In further defining “a dosage element . . . having an elongate shape” we can refer to aspect ratio, by which is meant the ratio or length to width. By width (or thickness) is meant a dimension perpendicular for the length. However such definitions are made potentially complicated by the fact that the dosage element of the invention may not be of regular shape. It could, for example, have one or two slanted ends so that “the length” needs further definition; and/or the cross-section may be irregular, so that “the width” needs further definition. It might be logical to define the length and width in terms of mean values but mean values may be difficult to determine and ultimately could be mathematical constructs rather than practical measures of value to the skilled person.

Having regard to the foregoing comments we have chosen to further define “a dosage element . . . having an elongate shape” using the following parameters: minimum length; maximum width; maximum cross-sectional area (that is, largest area perpendicular to the length); total surface area; and volume. Even if it may be thought that it would be more logical to use mean values, we prefer to use these maximum and minimum parameters, which do not require calculations, just measurement. We thereby ensure that we offer definitions which are practical and testable. All numerical definitions expressed herein are based on such parameters. Thus aspect ratio, for example, is the ratio of minimum length to maximum width.

The following definitions of dosage elements of the invention apply both to dosage elements which are monolithic and to dosage elements constituted by two or more pieces set end-to-end. In the latter embodiments the following definitions treat such dosage elements as if they were monolithic; for example length denotes the consolidated length, and surface area denotes the surface area of the dosage elements set end-to-end, not the summated surface area of the separated pieces.

Preferably the length (that is, the minimum length—see above) of a dosage element is at least 4 cm, preferably at least 5 cm, preferably at least 6 cm.

Preferably the length of a dosage element is up to 14 cm, preferably up to 12 cm, preferably up to 10 cm.

Preferably the thickness (that is, the maximum thickness—see above) of a dosage element is at least 0.8 cm, preferably at least 1.4 cm, preferably at least 1.8 cm.

Preferably the thickness of a dosage element is up to 5 cm, more preferably up to 3.5 cm, more preferably up to 2.5 cm.

Preferably the cross-sectional area (that is, the maximum cross-sectional area—see above) of a dosage element is at least 0.6 cm², preferably at least 1 cm², preferably at least 1.5 cm².

Preferably the cross-sectional area of a dosage element is up to 5 cm², preferably up to 3.5 cm², more preferably up to 2.5 cm².

Preferably the surface area of a dosage element is at least 30 cm², preferably at least 35 cm², preferably at least 40 cm².

Preferably the surface area of a dosage element is up to 60 cm², preferably up to 55 cm², preferably up to 50 cm².

Preferably the volume of a dosage element is at least 6 ml, preferably at least 9 ml, preferably at least 12 ml.

Preferably the volume of a dosage element is up to 25 ml, preferably up to 20 ml, preferably up to 16 ml.

Preferably the weight of a dosage element is at least 8 g, preferably at least 12 g, preferably at least 15 g.

Preferably the weight of a dosage element is up to 32 g, preferably up to 26 g, preferably up to 24 g.

Preferably a dosage element has an aspect ratio (that is, the ratio of minimum length to maximum thickness—see above) of at least 2:1, preferably at least 2.5:1, preferably at least 3:1.

Preferably a dosage element has an aspect ratio of up to 12:1, preferably up to 8:1, preferably up to 6:1.

Preferably a dosage element has a ratio of length to cross-sectional area of at least 2:1, preferably at least 2.5:1, preferably at least 3:1 (units of length⁻¹).

Preferably a dosage element has a ratio of length to cross-sectional area of up to 12:1, preferably up to 8:1, preferably up to 6:1 (units of length⁻¹).

Preferably a dosage element has a ratio of surface area to volume of at least 1.5:1, preferably at least 2:1, preferably at least 3:1 (units of length⁻¹).

Preferably a dosage element has a ratio of surface area to volume of up to 8:1, preferably up to 6:1, preferably up to 4:1 (units of length⁻¹).

The use of elongate dosage elements has a number of practical advantages. A plurality of elongate dosage elements, preferably identical but not necessarily so, may be set into a parallel array, as a row or, preferably around an axis. They may be set in a holder, which may be flexible, for example constructed of plastics sheet or film. If the holder is flexible and the dosage elements are in a parallel array, the holder may be manufactured flat and then rolled into a cylindrical array, and placed in a container (such as a tub or pot) of a dispensing device. The container may be of substantial construction, and the holder of insubstantial construction. In this way an inexpensive and effective disposable refill may be provided.

Embodiments employing a holder are useful particularly when dosage elements are constituted by two or more pieces set end-to-end. The pieces constituting a dosage element may be located in their position in the holder and functionally may then be no different from embodiments in which a monolithic dosage element is so located.

An elongate dosage element may be dissolved by the passage of water from one end of the element to the other. A dispensing chamber may be provided with an inlet for water at one end and an outlet at or towards a lower end, within which chamber an elongate solid dosage element is located.

Preferably the dosage element is of substantially the same cross-section along its length; in particular, it preferably does not taper. However embodiments which do taper or in which the cross-section varies in some other manner along the length of the dosage element are not excluded.

Preferably the dosage element is generally trigonal. This shape lends itself to setting an array of dosage elements into an array which can be formed into a rolled or folded form.

Preferably the dosage element is resistant to mechanical damage, for example as may occur in transit or by caused by mis-handling by a customer. Thus the cleaning composition requires suitable physical properties. For example, in layman's terms it is preferably not brittle or crumbly (alternatively stated, it is preferably tough and coherent). The tougher and more coherent the cleaning composition is, the thinner the dosage element can be. However there are further, external, factors which in practice limit to how thin a dosage element can be. These may include, for example, the nature of any refill into which such dosage elements are packed, the secondary packaging, handling during manufacture, the mode of transportation, and the temperature during storage or transportation. The skilled person will not have difficulty in determining the lower limit of dosage element, and the figures given above for width and cross-sectional area provide guidance.

In accordance with a second aspect to the present invention there is provided a dispensing device comprising a body and a plurality of dosage elements of the first aspect, the elements being provided in a parallel array, and retained in the body.

Preferably the body is generally cylindrical, and the array is also generally cylindrical, or configured to be generally cylindrical.

Preferably a dispensing device of the second aspect contains at least 6 dosage elements, more preferably at least 8, and most preferably at least 10.

Preferably a dispensing device of the second aspect contains up to 20 dosage elements, more preferably up to 18, and most preferably up to 16.

Preferably the dosage elements of a dispensing device of the second aspect are identical to each other, but could in some embodiments differ from each other.

In accordance with a third aspect of the invention there is provided the use of a dosage element in accordance with the first aspect or of a dispensing device in accordance with the second aspect, in carrying out washing in a ware washing machine.

In accordance with a fourth aspect there is provided a method of cleaning articles in a ware washing machine, comprising providing a dosage element in accordance with the first aspect or a dispensing device in accordance with the second aspect, in a part of the ware washing machine where the dosage element is dissolved by water.

Preferably a dispensing device is provided which has a plurality of dosage elements, and a plurality of washing operations is carried out, until the dosage elements are used up, whereupon a replacement array of dosage elements is introduced into the body.

Preferably one dosage element is dissolved per wash so that the plurality of washing operations is equal in number to the plurality of dosage elements provided. However this is not a necessity in the present invention; one could envisage methods in which more than one dosage element is required, in order to achieve good cleaning. As noted above a dosage element may be monolithic or may be constituted by two or more pieces set end-to-end.

The mechanism whereby the next dosage element is brought into operation (that is, exposed to water) may be manually or automatically operated.

A ware washing machine as defined herein may be a laundry (fabric) washing machine but is preferably a dishwashing machine.

The invention will now be further described, by way of example, with reference to the accompanying drawings, in which:

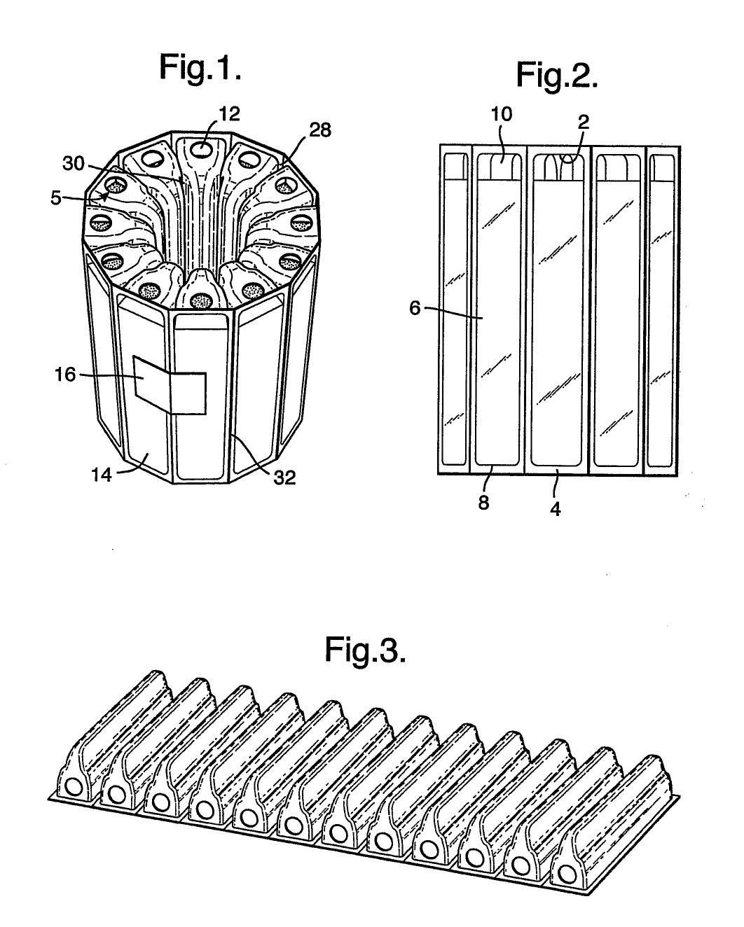

FIG. 1 shows an article of the present invention in nested form, in a perspective view, generally from above;

FIG. 2 shows the article of FIG. 1 in nested form, in side view;

FIG. 3 shows the article of FIG. 1 in flat form;

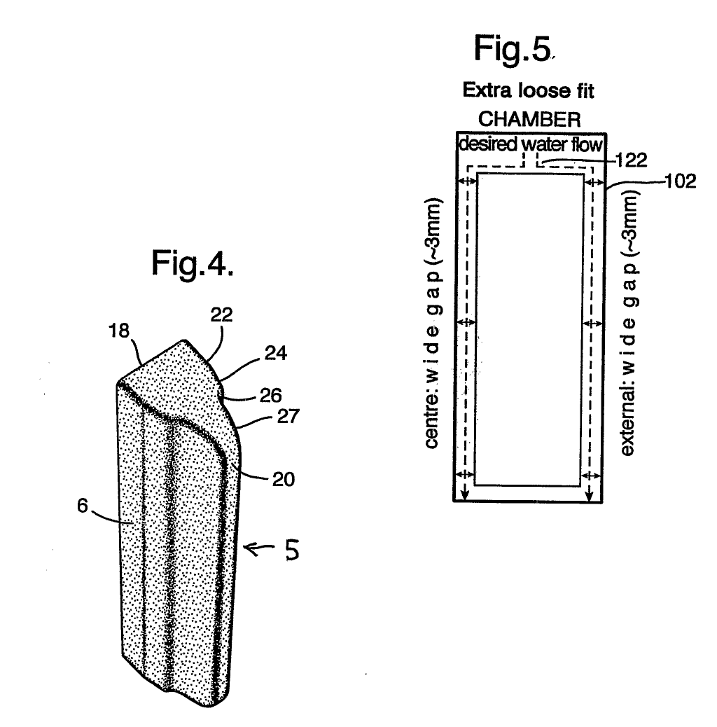

FIG. 4 shows the dosage element of FIG. 3 in plan view;

FIG. 5 shows a second embodiment, and is a schematic central vertical cross-sectional view of a second embodiment of unit dose element/chamber assembly in accordance with the invention, before wash-out;

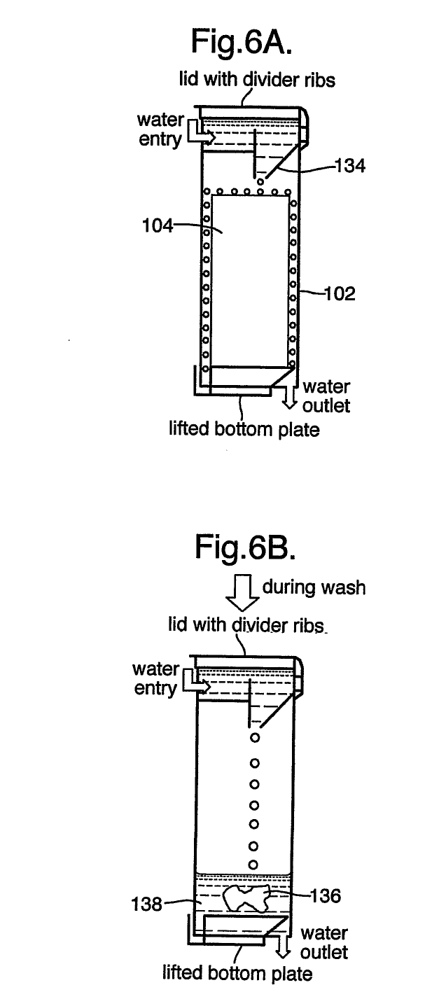

FIGS. 6A and 6B are schematic central vertical cross-sectional views of a third embodiment of unit dose element/chamber assembly in accordance with the invention, before and after wash-out; and

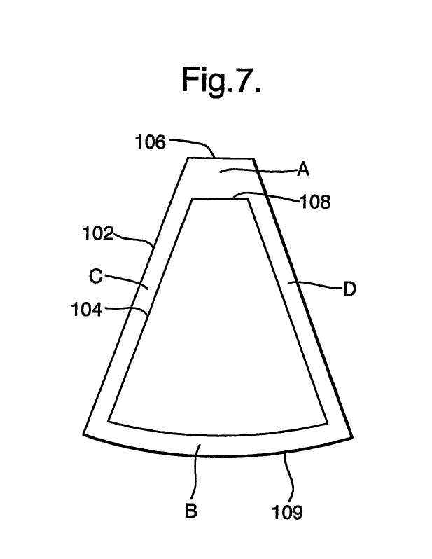

FIG. 7 is a plan view of the assemblies shown in FIGS. 56A and 6B.

The article of FIG. 1 is manufactured as a flat plastics tray of elongated blister pockets 2, shown in FIG. 3, comprising a thermoformed plastics tray. The open end of each blister pocket 2 is formed all around its perimeter with an endless flange 4 (which can be seen in FIG. 2). Elongate dosage elements in the form of solid rods or sticks 5 of a cleaning composition 6 (intended in this embodiment to be used for cleaning in an automatic dishwasher machine) are introduced into the blister pockets. This can be done in different ways. For example in one embodiment the cleaning composition can be injected or cast into the pockets. However in this embodiment the rods or sticks are pre-formed by injection moulding or extrusion, then cut to length, then introduced into the pockets. It may be noted that they are introduced into the pockets to fill each pocket to the bottom end 8, but to leave a space 10 at the top end. This space 10 is left so that water can enter the pocket, via opening 12 in the upper end wall of the pocket. In this embodiment each such opening 12 is circular, and 8 mm in diameter. An identical opening (not shown) is formed in the lower end wall of the article, to allow water and entrained or dissolved cleaning composition to exit the pocket.

Once all of the pockets have been provided with the rods or sticks of cleaning composition (by whatever means) a backing sheet 14 is laid over the open ends, and secured to the flanges 4. The backing may be adhered thereto by any convenient means, for example by heat or adhesive.

Next, the flat article, now in the form of a rack or linear array of rods or sticks, may be curled into its nested form shown in FIG. 1. In this embodiment the nested form is a generally cylindrical array. It may be retained in its nested form by a piece of adhesive tape 16.

As shown in FIG. 4, each rod or stick—and correspondingly each blister, has a flat base wall 18 abutting the backing sheet 14. From the base wall 18, each rod or stick, and each blister, generally tapers to a narrower distal end wall 20. The side walls initially taper gradually, as at 22, 24, then undergo a somewhat abrupt inward dislocation 26, then taper at an intermediate rate (between that of the side wall portion 22 and the dislocation 26) at 27, until the distal end wall 20 is reached.

The rods or sticks may be regarded as having the general shape of a triangular prism (i.e. trigonal). To be more precise, as noted above the side walls taper in a discontinuous manner.

It will be noted that the rods or sticks are located on the backing sheet with a separation 28 between them, at their base walls 18.

It may further be noted that the rods or sticks have a separation 30 between them, at their distal end region, when in their nested form.

The physical parameters of each rod or stick are as follows:
Length: 80 mm
Thickness (maximum value): 22 mm
Cross-sectional area: 2 cm²
Surface area: 40 cm²
Weight: 18.5 g
Volume: 14.8 cm³.
The backing sheet has, as a result of the mould into which it is thermoformed during manufacture, preferential fold lines 32. These fold lines 32 are aligned with the spacings 28 between the rods or sticks.

The end result of these features is as follows, and can be clearly seen in FIG. 1: when the article is formed into its nested shape the backing sheet is displaced about its fold lines 22, in an articulated manner. This nesting or folding is permitted by the spacings 28 and 30; if the sticks or rods simply abutted against each other the operation would not be permitted, due to physical obstruction. As can be seen in FIG. 1 the spacings 30 in the distal end regions may remain even in the nested form (though obviously narrowed).

The second and third embodiments will now be described with reference to FIGS. 5, 6A and 6B, in which the expected water flow pathway(s) is/are shown in dotted lines, and with reference to FIG. 7.

In each of these embodiments the chamber 102 and elongate dosage element 104 are wedge-shaped or trigonal in cross-section, as shown in FIG. 7. They are truncated, however, at the apex or central end 106, 108, leaving a substantial inner space, about 20 mm² in area. Each has an arcuate outside surface 109. However the position of the element 104 within the chamber 102 differs in different embodiments, as will be described.

Although the figures show single generally trigonal chambers they are in fact part of a rotary refill device which is segmented, each chamber of the device constituting one of the segments.

Each unit dose element 104 is a somewhat elongate body, formed by injection moulding. The composition is as described above. The unit dose element of FIG. 5 tapers slightly in the upwards direction. The chambers also taper slightly in the upwards direction, to match.

The physical parameters of each elongate dosage element used in the second and third embodiments, shown in FIGS. 5-7, are as follows:
Length: 72 mm
Thickness (maximum value): 18 mm
Cross-sectional area: 1.9 cm²
Surface area: 46 cm²
Weight: 17.8 g
Volume: 14.2 cm³.

Throughput of water in automatic dishwasher trials in each case was 200 ml/minute. The machine used was a Miele 651 SC, at the setting called “Normal 50° C.”.

In FIG. 5, exemplifying the present invention, a 3 mm gap A was left down the inside wall, at the apex of the wedge, and down the opposite, outside wall (see FIG. 7). Provided water was delivered to the central region 122 of the top wall of the unit dose element (“hereinafter “stick”) full dissolution was reliably achieved. It was observed that allowing some water to be collected in the chamber was of benefit in soaking then dissolving or dispersing any remaining small pieces of the composition. In this embodiment the gap B at the outside wall of the chamber is 1 mm and the gaps C, D at the side walls is 1 mm.

FIG. 6 also have the variation from the embodiment of FIG. 5, that a lift plate is provided, to raise the stick from the bottom of the chamber; but an additional variation is the design of the top of the chamber. The water inlet leads to a funnel 134. The funnel delivers water assuredly to the mid-region of the top face of the stick. It is found that complete dissolution occurs reliably. The dissolution of small residues such as 136 is aided by the fact that some water collects transiently in the chamber, as shown at 138. To facilitate this, the area of the outlet is 20-25 mm² and the area of the inlet is 8-11 mm².

1. A dosage element of a cleaning composition, having an elongate shape.

2. A dosage element as claimed in claim 1, of length in the range 4 cm to 14 cm.

3. A dosage element according to claim 1, of thickness in the range 0.8 cm to 3.5 cm.

4. A dosage element according to claim 1 having a cross-sectional area in the range 0.6 cm² to 5 cm².

5. A dosage element according to claim 1 having a surface area in the range 20 cm² to 60 cm².

6. A dosage element according to claim 1 having a volume in the range 6 ml to 25 ml.

7. A dosage element according to claim 1 having a weight in the range 8 g to 32 g.

8. A dosage element according to claim 1 having an aspect ratio in the range 2:1 to 12:1.

9. A dosage element according to claim 1 having a ratio of length to cross-sectional area in the range 2:1 to 12:1.

10. A dosage element according to claim 1 having a ratio of surface area to volume in the range 1:1 to 8:1.

11. A dosage element according to claim 1 which is monolithic but or constituted by two or more pieces set end-to-end.

12. A dosage element according to claim 1 which is generally trigonal.

13. A dosage element according to claim 1 which is an extruded or compacted body.

14. A dispensing device comprising a body and a plurality of dosage elements according to claim 1, the elements being provided in a parallel array, and retained in the body.

15. A dispensing device according to claim 14, wherein the body is generally cylindrical, and the array is also generally cylindrical, or configurable to be generally cylindrical.

16. A dispensing device according to claim 14, which contains from 6 to 20 dosage elements.

17. A method of washing in a ware washing machine comprising the step of utilizing a dosage element according to claim 1 during washing.

18. A method of cleaning articles in a ware washing machine, comprising the steps of: providing a dosage element according to claim 1 in a part of the ware washing machine, and dissolving the dosage element with water.

19. (canceled)

20. A method of washing in a ware washing machine comprising the step of utilizing a dosage element according to claim 1 during washing.

21. A method of cleaning articles in a ware washing machine, comprising the steps of: providing a dispensing device containing a dosage element according to claim 14 in a part of the ware washing machine, and dissolving the dosage element with water.
